(19) United States
(12) Patent Application Publication
(10) Pub. No.: US 2022/0160011 A1
(43) Pub. Date: May 26, 2022

(54) THICKENING COMPOSITION

(71) Applicant: DuPont Nutrition Biosciences ApS, Copenhagen K (DK)

(72) Inventors: Graham Sworn, Paris (FR); Niall Young, Copenhagen K (DK); Karen Falck, Copenhagen K (DK); Nobuko Jinno, Tokyo (JP); Yoshio Toyama, Tokyo (JP)

(21) Appl. No.: 17/440,997

(22) PCT Filed: Mar. 19, 2020
(86) PCT No.: PCT/JP2020/012463

§ 371 Date: Sep. 20, 2021

(30) Foreign Application Priority Data
Mar. 22, 2019 (JP) 2019-055505

(51) Int. Cl. A23L 29/262; A23L 29/269; A23L 29/256

(52) U.S. Cl. CPC A23L 29/262; A23V 2002/00; A23L 29/256; A23L 29/27

(57) ABSTRACT

The present invention provides a composition for providing thickness to foods and drinks and improving swallowability for foods and drinks. More specifically, the present invention is a composition comprising a first thickener and a second thickener for providing thickness to foods and drinks and improving swallowability for foods and drinks, wherein

the first thickener shows pseudoplasticity at the shear rate from 1 to 100S⁻¹,

the second thickener shows Newtonian viscosity at the shear rate from 1 to 100S⁻¹,

and the thickeneing effect when the first and the second thickeners are used in combination in an equal amount is equal to or less than an additive level of the thickening effect when each were used alone.

### CROSS-REFERENCE TO RELATED APPLICATIONS

This application represents a national filing under 35 U.S.C. 371 of International Application No. PCT/JP2020/012463 filed Mar. 19, 2020, and claims priority of Japanese Patent Application No. 2019-055505 filed Mar. 22, 2019, the contents of both applications are incorporated herein by reference in their entirety for all purposes.

### FIELD OF THE INVENTION The present invention relates to a thickening composition.

### BACKGROUND TECHNOLOGY

In order to prevent aspiration, efforts are made to thicken smooth liquids for people with dysphagia. The degree of such thickening varies depending on the severity or swallowing state of the patient, and specialists such as doctors, speech therapists (ST), nutritionists, or the like are required to adjust the thickening in accordance with the behavior of the individual patients.

A frequently used component for giving thickness is, for example, xanthan gum which is a thickening component (Patent Document 1). However, with respect to the thickening method by using polysaccharide thickeners which significantly exhibit a higher viscosity with a higher shear flowability, i.e., a lower shear rate, such like xanthan gum, when the viscosity was adjusted high, based on the thickening standard of an academic conference as set by a measuring method with a high shear rate of 50s⁻¹, the viscosity at the low shear rate is significantly increased, leading to a problem in which flow is worsened in the mouth and the space of the throat. Especially, it is essential to provide thickness to beverages such as teas which have a smooth and watery mouthfeel in view of preventing aspiration. However, there was a problem that an excessive strong thickening resulted in impairment of mouthfeel or that the thickening turned out to cause difficulty in swallowing, increasing the risk of residues at the throat. In addition, adjustment of thickening was extremely difficult.

### RELATED ART DOCUMENTS

### Patent Documents

Patent Document 1 Japanese Unexamined Patent Application Publication No. 2015-0514790

### SUMMARY OF THE INVENTION

When 2 kinds of thickeners are combined, an interaction (a synergetic action) often occurs to exhibit a viscosity greater than the additive viscosity of the respective viscosities of such 2 kinds of thickeners. Suprisingly, the present inventors have found that when a first thickener showing pseudoplasticity at the shear rate from 1 to 100S⁻¹ and a second thickener showing Newtonian viscosity at the shear rate from 1 to 100S⁻¹ are combined, an appropriate thickening will be provided to foods and drinks and swallowability for foods and drinks will be improved without such interaction. The present invention is based on such finding.

Therefore, the object of the present invention is to provide a composition which provides thickness to foods and drinks and improves swallowability for foods and drinks.

According to the present invention, the following inventions are provided.

<1>A composition comprising a first thickener and a second thickener for providing thickness to foods and drinks and improving swallowability for foods and drinks, wherein the first thickener shows pseudoplasticity at the shear rate from 1 to 100S⁻¹, the second thickener shows Newtonian viscosity at the shear rate from 1 to 100S⁻¹, and the thickeneing effect when the first and the second thickeners are used in combination in an equal amount is equal to or less than an additive level of the thickening effect when each were used alone.

<2>The composition according to <1>, wherein n is from −1 to −0.7 when fluid characteristics of the first thickener is expressed by the following formula (1):

[Equation 1]

P=μDⁿ (1)

wherein P represents the shear stress (Pa), D represents the shear rate (s⁻¹), p represents a non-Newtonian viscosity coefficient, and n represents a non-Newtonian viscosity index.

<3> The composition according to <1>or <2>, wherein the first thickener is at least one selected from the group consisting of xanthan gum, succinoglycan gum, gellan gum fluid gel, and crystalline cellulose.

<4> The composition according to any one of <1>to <3>, wherein n is from −0.15 to 0.15 when fluid characteristics of the second thickener is expressed by the following formula (1):

[Equation 2]

P=μDⁿ (1)

wherein P represents the shear stress (Pa), D represents the shear rate (s⁻¹), p represents a non-Newtonian viscosity coefficient, and n represents a non-Newtonian viscosity index.

<5> The composition according to any one of <1> to <4>, wherein the second thickener is at least one selected from the group consisting of carboxymethyl cellulose, guar gum, alginic acid and pectin.

<6> The composition according to any one of <1> to <5>for ingestion aid for a person with dysphagia, wherein said composition is ingested as a mixture with foods and drinks.

<7> The composition according to any one of <1> to <6>, wherein the mass ratio of the first thickener to the second thickener (first thickener/second thickener) is from 20/80 to 90/10.

<8> The composition according to any one of <1> to <7>, wherein the content of the first thickener is from 15 to 95% by mass.

<9> The composition according to any one of <1> to <8>, wherein the content of the second thickener is from 5 to 85% by mass.

<10> The composition according to any one of <1> to <9>, wherein the total mixed amount of the first and the second thickeners is from 0.1 to 3% by mass based on the whole amount of a mixture of said composition and foods and drinks.

<11> The composition according to any one of <2> to <10>, wherein the ratio of c to b (c/b) is 1.1 or more and the ratio of b to a (b/a) is 0.9 or less, when fluid characteristics of said composition is expressed by the following formula (1):

[Equation 3]

P=μDⁿ (1)

wherein P represents the shear stress (Pa), D represents the shear rate (s⁻¹), p represents a non-Newtonian viscosity coefficient, and n represents a non-Newtonian viscosity index, when n is a if D is from 0.1 to 1, n is b if D is greater than 1 to 100 or less, and n is c if D is greater than 100 to 1000 or less in formula (1).

<12> The composition according to any one of <1> to <11>, wherein said composition is in a liquid form, powder, or a granular form.

The composition according to the present invention can give thickness to foods and drinks and improve swallowability for foods and drinks.

### BRIEF DESCRIPTION OF THE DRAWINGS

FIG. 1 illustrates a graph of fluid characteristics of xanthan gum and/or cellulose gum BEV150. X-axis shows the shear rate (s⁻¹) and Y-axis shows the viscosity (Pa·s). The solid line graph with black triangles shows blend 0-80, the solid line graph with black diamonds shows blend 4, the solid line graph with black squares shows blend 11, the solid line graph with symbols+shows blend 2, the solid line graph with white triangles shows blend 3, the solid line graph with white diamonds shows blend 15, and the solid line graph with symbols X shows BEV150 respectively.

FIG. 2 illustrates a graph of fluid characteristics of xanthan gum and/or cellulose gum BEV130. X-axis shows the shear rate (s⁻¹) and Y-axis shows the viscosity (Pa·s). The solid line graph with black triangles shows blend 0-80, the solid line graph with black diamonds shows blend 12, the solid line graph with black squares shows blend 5, the solid line graph with symbols+shows blend 8, the solid line graph with white triangles shows blend 13, the solid line graph with white diamonds shows blend 19, and the solid line graph with symbols X shows BEV130 respectively.

FIG. 3 illustrates a graph of a fluid characteristic of a thickening composition (xanthan gum and carboxymethyl cellulose). X-axis shows the shear rate (s⁻¹) and Y-axis shows the viscosity (Pa·s). The solid line represents blend 0-80 and the dotted line represents blend 3 respectively. Also, the area colored in gray represents the area in which the graphs of blends 116-131 are plotted.

FIG. 4A illustrates a graph of a fluid characteristic of blend 121. X-axis shows the shear rate(s⁻¹) and Y-axis shows the viscosity (Pa·s). The solid line graph with symbols+represents blend 121, the broken line graph with black circles represents blend 3, and the solid line graph with black triangles represents blend 0-80 respectively.

FIG. 4B illustrates a graph of a fluid characteristic of blend 125. X-axis shows the shear rate(s⁻¹) and Y-axis shows the viscosity (Pa·s). The solid line graph with symbols+represents blend 125, the broken line graph with black circles represents blend 3, and the solid line graph with black triangles represents blend 0-80 respectively.

FIG. 4C illustrates a graph of a fluid characteristic of blend 127. X-axis shows the shear rate(s⁻¹) and Y-axis shows the viscosity (Pa·s). The solid line graph with symbols+represents blend 127, the broken line graph with black circles represents blend 3, and the solid line graph with black triangles represents blend 0-80 respectively.

FIG. 4D illustrates a graph of a fluid characteristic of blend 128. X-axis shows the shear rate(s⁻¹) and Y-axis shows the viscosity (Pa·s). The solid line graph with symbols +represents blend 128, the broken line graph with black circles represents blend 3, and the solid line graph with black triangles represents blend 0-80 respectively.

FIG. 5A is a graph of non-Newtonian viscosity index (fluidity index) of the aqueous solutions obtained from blend 0-80. X-axis shows the shear rate (s⁻¹) and Y-axis shows the shear stress (Pa). The black diamonds represent plots in the range of the shear rate from 0.1 to 1 s⁻¹, the black squares represent plots in the range of the shear rate from 1 to 100 s⁻¹, and the black triangles represent plots in the range of the shear rate from 100 to 1000 s⁻¹ respectively.

FIG. 5B is a graph of non-Newtonian viscosity index (fluidity index) of the aqueous solutions obtained from BEV130. X-axis shows the shear rate (s⁻¹) and Y-axis shows the shear stress (Pa). The black diamonds represent plots in the range of the shear rate from 0.1 to 1 s⁻¹, the black squares represent plots in the range of the shear rate from 1 to 100 s⁻¹, and the black triangles represent plots in the range of the shear rate from 100 to 1000 s⁻¹ respectively.

FIG. 5C is a graph of non-Newtonian viscosity index (fluidity index) of the aqueous solutions obtained from blend 19. X-axis shows the shear rate (s⁻¹) and Y-axis shows the shear stress (Pa). The black diamonds represent plots in the range of the shear rate from 0.1 to 1 s⁻¹, the black squares represent plots in the range of the shear rate from 1 to 100 s⁻¹, and the black triangles represent plots in the range of the shear rate from 100 to 1000 s⁻¹ respectively.

FIG. 6 illustrates a graph of a fluid characteristic of a thickening composition (xanthan gum and alginic acid). X-axis shows the shear rate(s⁻¹) and Y- axis shows the viscosity (Pa·s). The solid line graph with black triangles represents blend 0-80, the solid line graph with black diamonds represents XG/BEV130, the solid line graph with black squares represents XG/alginic acid, the solid line graph with symbols X represents BEV130, and the solid line graph with symbols +represents alginic acid respectivey.

FIG. 7 shows a graph of a fluid characteristic of an aqueous solution obtained from a thickening composition (succinoglycan and carboxymethyl cellulose). X-axis shows the shear rate (s⁻¹) and Y-axis shows the viscosity (Pa·s). The solid line graph with black triangles represents succinoglycan, the solid line graph with black diamonds represents blend 34, the solid line graph with black squares represents blend 36, the solid line graph with black circles represents blend 37, and the solid line graph with symbols X represents BEV130 respectivey.

FIG. 8 shows a spider diagram of the statistical analysis result from the sensual evaluation scores of the aqueous solutions obtained from the thickening compositions (blends 3, 121, 125, 127, 128, and 0-80). The solid line graph with black triangles shows blend 0-80, the solid line graph with black diamonds shows blend 3, the solid line graph with black squares shows blend 128, the solid line graph with black circles shows blend 127, the solid line graph with symbols+shows blend 125, and the solid line graph with symbols X shows blend 121 respectivey.

### DETAILED DESCRIPTION OF THE INVENTION

According to one embodiment of the present invention, there is provided a composition comprising a first thickener and a second thickener for providing thickness to foods and drinks and improving swallowability for foods and drinks.

### First Thickener

The first thickener as used in the present invention refers to a thickener showing pseudoplasticity at the shear rate from 1 to 100s⁻¹. In this connection, the pseudoplasticity is a type of non-Newtonian property and non-Newtonian property refers to a flowing property of a fluid having a shear stress and shear rate which is contrary to the Newton's Law of Viscosity. In a pseudoplastic fluid, the rate of increase of the shear stress decreases along with the increase of the shear rate and the viscosity varies depending on the shear rate. The pseudoplasticity (relation between shear stress and shear rate) of the first thickener is determined by a graph of non-Newtonian viscosity index (fluidity index) derived from the relation between the shear rates of at least two points and the shear stress which can be calculated from the viscosity in such shear rates by using a commercially available viscoelasticity measuring instrument which is well-known by the person skilled in the art. The shear stress (Pa) can be calculated from multiplying the viscosity (Pa·s) by the shear rate (1/s). Otherwise, the shear stress value may be used which is displayed on a commercially available viscoelasticity measuring instrument equipped with an automated computational function. The pseudoplasticity of the first thickener is specifically determined by the method as shown in the Examples to be explained below.

Any thickener showing pseudoplasticity at the shear rate from 1 to 100 s⁻¹ can be used as the first thickener as used in the present invention. Said thickener used may be those produced by using microorganisms following normal methods or commericially available products. For example, a commericially available food additive of a thickener showing said pseudoplasticity can be used. Said thickener may be used alone or by combining 2 or more kinds. According to a preferable embodiment of the present invention, when fluid characteristics of the first thickener used in the present invention is expressed by the following formula (1), n is from −1 to −0.7:

[Equation 4]

P=μDⁿ (1)

wherein P represents the shear stress (Pa), D represents the shear rate (s⁻¹), p represents a non-Newtonian viscosity coefficient, and n represents a non-Newtonian viscosity index.

Formula (1) is also called a viscosity formula and the viscosity (25° C., Pa·s) can be measured by using a viscoelasticity measuring instrument: MCR501 Rheometer (Anton Parr) in formula (1) (refer to Example 1 to be explained below). According to the present invention, the viscosity of the non-Newtonian fluid varies depending on the shear rate. Therefore, in the present invention, the fluid characteristics of the composition according to the present invention is expressed by the range of non-Newtonian viscosity index (also called fluidity index) n which is derived from the relation between the shear rates of at least two points and the shear stress which can be calculated from the viscosity in such shear rates. For example, the shear rate region to be measured can be expanded to the range of 0.1 to 100/s and 1 to 100/s, depending on the device, and this range can be adjusted if necessary. The shear stress (Pa) can be calculated from multiplying the viscosity (Pa·s) by the shear rate (1/s). Otherwise, the shear stress value may be used which is displayed on a commercially available viscoelasticity measuring instrument equipped with an automated computational function.

According to a preferred embodiment of the present invention, the first thickener used in the present invention is selected from the group consisting of xanthan gum, succinoglycan gum, gellan gum, and crystalline cellulose, and xanthan gum is more preferable. These thickeners may be used alone or by combining 2 or more kinds.

Xanthan gum is a polysaccharide which can be produced from fermentation of sugars such as starches with Xabthomonas campestris. Xanthan gum used may be those produced by using microorganisms following normal methods or commericially available products. Examples of the commercially available products include SAN ACE (San-Ei Gen FFI Co., Ltd.), KELTROL (CP Kelco), ECHO GUM (DSP GOKYO FOOD & CHEMICAL Co., Ltd.), GRINDSTED Xanthan Clear80 (Du Pont), and GRINDSTED Xanthan MAS-SH clear (Du Pont).

Succinoglycan gum is a polysaccharide which can be produced from fermentation of sugars such as starches with Agrobacterium tumefaciens. Succinoglycan gum used may be those produced by using microorganism following normal methods or commercially available products. As for the commercially available products, for example, GRINDSTED succinoglycan J (Du Pont) may be used.

Gellan gum is a polysaccharide which can be produced from Sphingomonas elodea and comprises HA gellan gum containing high acyl groups and LA gellan gum in which the acyl groups are removed. Gellan gum used may be those produced by using microorganism following normal methods or commercially available products. As for the commercially available products, for example, KELCOGELLT100 (CP Kelco), Kelcogel HMB-P (CP Kelco), KELCOGELHT (CP Kelco), GELLAN NM 205 (Du Pont), and Gellan Gum DAI90 (Du Pont) may be used.

Crystalline cellulose is formed by partial depolymerization of alpha-cellulose with acid. Crystalline cellulose used may be those produced by using microorganism following normal methods or commercially available products. As for the commercially available products, for example, GRINDSTED MCC (Du Pont) and CEOLUS (Asahi Kasei Corporation) may be used.

### Second Thickener

The second thickener used in accordance with the present invention refers to a thickener showing Newtonian viscosity at the shear rate from 1 to 100s⁻¹. In this context, the Newtonian viscosity shows an almost the same, close property with the Newton fluid. Newtonian property means the fluid property wherein the relationship between the shear stress and the shear rate is in accordance with the Newton's Law of Viscosity, i.e., in which the viscosity becomes constant regardless of shear rate of the fluid. Therefore, the viscosity of the Newtonian viscous fluid can be almost constant (a horizontal straight line) against the shear rate when expressed in a viscosity curve. The Newtonian viscosity (relation between shear stress and shear rate) of the second thickener is determined by a graph of non-Newtonian viscosity index (fluidity index) derived from the relation between the shear rates of at least two points and the shear stress which can be calculated from the viscosity in such shear rates by using a commercially available viscoelasticity measuring instrument which is well-known by the person skilled in the art. The shear stress (Pa) can be calculated from multiplying the viscosity (Pa·s) by the shear rate (1/s). Otherwise, the shear stress value may be used which is displayed on a commercially available viscoelasticity measuring instrument equipped with an automated computational function. The Newtonian viscosity of the second thickener is specifically determined by a method shown in the Examples to be explained below.

Any thickener showing Newtonian viscosity at the shear rate from 1 to 100 s⁻¹ can be used as the second thickener as used in the present invention. Said thickener used may be those produced by using microorganisms following normal methods or commericially available products. For example, a commericially available food additive of a thickener showing said Newtonian viscosity can be used. Said thickener may be used alone or by combining 2 or more kinds.

According to a preferred embodiment of the present invention, when fluid characteristics of the second thickener used in the present invention is expressed by the above formula (1), n is, for example, from −0.6 to 0.15, more preferably from −0.15 to 0.15, furthermore preferably from −0.1 to 0.1, furthermore preferably from −0.05 to 0.05. Preferably, n is near 0 for the second thickener.

According to a preferred embodiment of the present invention, the second thickener used in the present invention is selected from the group consisting of carboxymethyl cellulose, alginic acid, and pectin, and carboxymethyl cellulose is preferable. These thickeners may be used alone or by combining 2 or more kinds. Since the second thickener has the Newtonian viscosity, the average molecular weight of the thickener is not limited due to the fact that it can be used even when in an aqueous solution form regardless of the viscosity and for example, a thickener having an average molecular weight from 5000 to 10000000 may be used.

Carboxymethyl cellulose (also called CMC or cellulose gum) is a derivative of cellulose. Conventionally, carboxymethyl cellulose is a component that has not been used with an intention to provide thickness. Commercially available carboxymethyl cellulose includes SUNROSE (NIPPON PAPER Co., Ltd), Cello gen F (DKS Co., Ltd.), CMC Daicel (Daicel FineChem Ltd.), GRINDSTED BEV130 (Du Pont), GRINDSTED BEV150 (Du Pont), and GRINDSTED BEV350 (Du Pont), and preferred are GRINDSTED BEV130 (Du Pont) (low viscosity: 2%, 800 to 1600 mPa·s), GRINDSTED BEV150 (Du Pont) (medium viscosity: 1%, 1500 to 3500 mPa·s), and GRINDSTED BEV350 (Du Pont) (high viscosity: 1%, 3000 to 5000 mPa·s).

Alginic acid is a brown alga origin polysaccharide and for example, Kimica algin (KIMICA Corporation) may be used.

Pectin is a complex polysaccharide and for example, GRINDSTED PECTIN (Du Pont) may be used.

The composition according to the present invention comprises a first thickener and a second thickener. According to one embodiment, the thickening effect when the first and the second thickeners are used in combination in an equal amount in the composition is equal to or less than an additive level of the thickening effect when each were used alone.

According to a preferred embodiment of the present invention, the combinations of the first thickener and the second thickener of the composition of the present invention are xanthan gum and carboxymethyl cellulose, xanthan gum and alginic acid, and succinoglycan gum and carboxymethyl cellulose, and more preferably is xanthan gum and carboxymethyl cellulose.

According to a preferred embodiment of the present invention, the mass ratio of the first thickener to the second thickener (first thickener/second thickener) is from 20/80 to 90/10, more preferably from 30/70 to 85/15, furthermore preferably from 30/70 to 80/20, furthermore preferably from 30/70 to 60/40, especially more preferably from 40/60 to 60/40.

According to a preferred embodiment of the present invention, the content of the first thickener is from 15 to 95% by mass, more preferably from 20 to 90% by mass, furthermore preferably from 20 to 85% by mass, furthermore preferably from 20 to 70% by mass, especially more preferably from 30 to 70% by mass.

According to a preferred embodiment of the present invention, the content of the second thickener is from 5 to 85% by mass, more preferably from 10 to 80% by mass, furthermore preferably from 15 to 80% by mass, furthermore preferably from 30 to 80% by mass, especially more preferably from 30 to 70% by mass.

According to a preferred embodiment of the present invention, wherein the ratio of c to b (c/b) is 1.1 or more and the ratio of b to a (b/a) is 0.9 or less, when fluid characteristics of the composition of the present invention is expressed by the above formula (1), when n is a if D is from 0.1 to 1, n is b if D is greater than 1 to 100 or less, and n is c if D is greater than 100 to 1000 or less.

The fluid characteristics (relation between shear stress and shear rate) of the composition of the present invention is determined by a graph of non-Newtonian viscosity index (fluidity index) derived from the relation between the shear rates of at least two points and the shear stress which can be calculated from the viscosity in such shear rates by using a commercially available viscoelasticity measuring instrument which is well-known by the person skilled in the art. The shear stress (Pa) can be calculated from multiplying the viscosity (Pa ·s) by the shear rate (1/s). Otherwise, the shear stress value may be used which is displayed on a commercially available viscoelasticity measuring instrument equipped with an automated computational function. The fluid characteristics of the composition of the present invention are specifically determined by the method as shown in the Examples to be explained below.

The composition of the present invention will provide an appropriate thickness together with improvement in swallowability for foods and drinks by combining the first thickener showing pseudoplasticity at the shear rate from 1 to 100s⁻¹ and the second thickener showing Newtonian viscosity at the shear rate from 1 to 100s⁻¹. The swallowability for foods and drinks can be scored by sensory evaluation tests when foods and drinks were taken and the results thereof can be conduced by the method of Example 4 to be explained below.

According to a preferred embodiment of the present invention, the composition of the present invention may be used for ingestion aid for a person with dysphagia, wherein said composition is ingested as a mixture with foods and drinks.

A person with dysphagia refers to a person who has a decreased swallowing function. A person with dysphagia tends to cause the so-called aspiration, where foods and drinks are accidentally run through the trachea when swallowing which likely results in pneumonia, death by asphyxiation, or the like. Dysphagia is identified a great deal not only in results of acute events of surgeries of brain stroke, brain injury, buccal cancer or pharyngeal cancer, and patients with nervous system diseases, but also in aged persons having a decreased swallowing function.

A composition for ingenstion aid for the person with dysphagia refers to a composition which will facilitate the ingestion (support the ingestion) of the person with dysphagia through its use by mixing with ingestible foods and drinks. When the composition of the present invention is mixed with foods and drinks, appropriate thickness will be provided to foods and drinks, especially beverages, and there can be obtained foods and drinks which are unlikely to be accidentally swallowed, i.e. foods and drinks which are easily ingested for a person with dysphagia.

Foods and drinks are those other than medicines and may be, without particular limitation, in an orally ingestible form such as solutions, suspensions, emulsions, powders, solid forms, or the like. In particular, foods and drinks include, for example, instant foods such as instant noodles, retort foods, canned foods, microwave foods, instant soups and miso soups, and freeze-dried foods; drinks such as refreshment drinks, fruit juices, vegetable juices, soy-bean milk drinks, coffee drinks, tea drinks, powder drinks, concentrated drinks, and alcohols; flower products such as bread, spaghetti, noodles, cake mixtures, and breadcrumbs; seasonings such as sauces, tomato processed seasonings, flavor seasonings, seasoning mixtures, bastings, dressings, flavored stocks, and curry/stew stocks; oils such as processed oils, butter, margarine, and mayonnaise; dairy products such as milk beverages, yoghurts, lactic acid beverages, ice creams, and creams; agricultural processed foods such as canned agricultural foods, jams/marmalades, and cereals; and frozen foods or the like. Foods and drinks used in accordance with the present invention are preferably beverages from the respect that the composition according to the present invention is capable of providing appropriate thickness while a smooth watery mouthfeel is kept.

According to a preferred embodiment of the present invention, the total mixed amount of the first and the second thickeners is from 0.1 to 3% by mass, more preferably from 0.4 to 2% by mass, furthermore preferably from 0.5 to 1.5% by mass, based on the whole amount of a mixture of the composition according to the present invention and foods and drinks.

The form of composition according to the present invention is not particularly limited, as long as it is easy for mixing with foods and drinks and may be a liquid form, powder, or a granular form. According to a preferred embodiment of the present invention, the form is a liquid since it can be stirred rapidly without forming lumps in the beverages.

According to another embodiment of the present invention, there is provided a method for producing a composition for providing thickness to foods and drinks and improving swallowability, comprising adjusting the shear stress and the shear rate of said composition such that the following formulae (2) to (4) are satisfied:

[Equation 5]

y=0.1889x^{-0.521} (x is from 0.1 to 1) (2)

y=0.194x^{-0.19} (x is greater than 1 to 100 or less) (3)

y=0.3808x^{-0.328} (x is greater than 100 to 1000 or less) (4)

wherein y represents the shear stress (Pa) and x represents the shear rate (S⁻¹).

According to another embodiment of the present invention, there is provided a method for providing thickness to foods and drinks and improving swallowability, comprising adding to foods and drinks a composition having the shear stress and the shear rate which satisfy the following formulae (2) to (4):

[Equation 6]

y=0.1889x^{-0.521} (x is from 0.1 to 1) (2)

y=0.194x^{0.19} (x is greater than 1 to 100 or less) (3)

y =0.3808x^{0.328} (x is greater than 100 to 1000 or less) (4)

wherein y represents the shear stress (Pa) and x represents the shear rate(S⁻¹).

According to another embodiment of the present invention, a method for providing thickness to foods and drinks and improving swallowability for foods and drinks, comprising adding to foods and drinks a composition comprising a first thickener and a second thickener, wherein the first thickener shows pseudoplasticity at the shear rate from 1 to 100 S⁻¹ and the second thickener shows Newtonian viscosity at the shear rate from 1 to 100 S⁻¹, is provided.

According to another embodiment of the present invention, a method for aiding an ingestion for a person with dysphagia, comprising allowing a person with dysphagia to ingest a mixture of foods and drinks and a composition comprising a first thickener and a second thickener, wherein the first thickener shows pseudoplasticity at the shear rate from 1 to 100 S⁻¹ and the second thickener shows Newtonian viscosity at the shear rate from 1 to 100 S⁻¹, is provided. Here, according to another preferred embodiment of the present invention, the method excludes medical interventions for humans.

According to another embodiment of the present invention, a use of a combination product of a first thickener and a second thickener, in the manufacture of a composition for ingestion aid for a person with dysphagia, wherein the composition is ingested as a mixture with foods and drinks, and wherein the first thickener shows pseudoplasticity at the shear rate from 1 to 100 S⁻¹ and the second thickener shows Newtonian viscosity at the shear rate from 1 to 100 5⁻¹, is provided.

According to another embodiment of the present invention, a use of a combination product of a first thickener and a second thickener, in the manufacture of a composition for providing thickness to foods and drinks and improving swallowability for foods and drinks, wherein the first thickener shows pseudoplasticity at the shear rate from 1 to 100 S⁻¹ and the second thickener shows Newtonian viscosity at the shear rate from 1 to 100 S⁻¹, is provided.

According to another embodiment of the present invention, a combination product of a first thickener and a second thickener, for ingestion aid for a person with dysphagia, wherein the composition is ingested as a mixture with foods and drinks, and wherein the first thickener shows pseudoplasticity at the shear rate from 1 to 100 S⁻¹ and the second thickener shows Newtonian viscosity at the shear rate from 1 to 100 S⁻¹, is provided.

According to another embodiment of the present invention, a combination product of a first thickener and a second thickener, for providing thickness to foods and drinks and improving swallowability for foods and drinks, and wherein the first thickener shows pseudoplasticity at the shear rate from 1 to 100 S⁻¹ and the second thickener shows Newtonian viscosity at the shear rate from 1 to 100 S⁻¹, is provided.

According to another embodiment of the present invention, a use of a combination product of a first thickener and a second thickener, for ingestion aid for a person with dysphagia, wherein the composition is ingested as a mixture with foods and drinks, and wherein the first thickener shows pseudoplasticity at the shear rate from 1 to 100 S⁻¹ and the second thickener shows Newtonian viscosity at the shear rate from 1 to 100 S⁻¹, is provided. According to one preferred embodiment of the present invention, a use of the present invention is non-therapeutic use.

According to another embodiment of the present invention, a use of a combination product of a first thickener and a second thickener, for providing thickness to foods and drinks and improving swallowability for foods and drinks, and wherein the first thickener shows pseudoplasticity at the shear rate from 1 to 100 S⁻¹ and the second thickener shows Newtonian viscosity at the shear rate from 1 to 100 S⁻¹, is provided.

The embodiment of the method, use and combination product as mentioned above can be performed in accordance with the description on the composition of the present invention.

### EXAMPLES

### Example 1: Thickening Composition Comprising Xanthan Gum and Cellulose Gum

### (1) Measurement of Fluid Characteristics (Flow Curve)

Each thickening composition was prepared in accordance with the blends as described in the following Table 1. As for xanthan gum were used, GRINDSTED Xanthan clear 80 (Du Pont) and GRINDSTED Xanthan MAS-SH clear (Du Pont). As for cellulose gum (carboxymethyl cellulose) were used, GRINDSTED BEV130 (Du Pont) (Low viscosity: 2%, from 800 to 1600 mPa·s), GRINDSTED BEV150 (Du Pont) (Medium viscosity: 1 %, from 1500 to 3500 mPa·s), and GRINDSTED BEV350 (Du Pont) (High viscosity: 1%, from 3000 to 5000 mPa·s).

TABLE 1
Blending Component of Each Thickening
Composition of Example 1

| | Xanthan gum | | Cellulose gum | | |
|---|---|---|---|---|---|
| | Xanthan | Xanthan | BEV | BEV | BEV |
| Blend No. | clear 80 | MAS-SH clear | 130 | 150 | 350 |
| BEV150 | | | | 100 | |
| BEV130 | | | 100 | | |
| 0-80 | 100 | | | | |
| 2 | 50 | | | 50 | |
| 3 | 40 | | | 60 | |
| 4 | 70 | | | 30 | |
| 5 | 60 | | 40 | | |
| 8 | 50 | | 50 | | |
| 11 | 60 | | | 40 | |
| 12 | 70 | | 30 | | |
| 13 | 40 | | 60 | | |
| 15 | 30 | | 70 | | |
| 19 | 30 | | 70 | | |
| 116 | | 30 | 70 | | |
| 117 | | 30 | | 70 | |
| 118 | | 30 | | | 70 |
| 119 | | 30 | 35 | | 35 |
| 120 | | 40 | 60 | | |
| 121 | | 40 | | 60 | |
| 122 | | 40 | | | 60 |
| 123 | | 40 | 30 | | 30 |
| 124 | | 50 | 50 | | |
| 125 | | 50 | | 50 | |
| 126 | | 50 | | | 50 |
| 127 | | 50 | 25 | | 25 |
| 128 | | 60 | 40 | | |
| 129 | | 60 | | 40 | |
| 130 | | 60 | | | 40 |
| 131 | | 60 | 20 | | 20 |

Note)
Values of the component composition of each thickening composition represent part(s) by mass.

With respect to the thickening compositions of blends 0-80, 2 to 5, 8, 11 to 13, 15, and 19, the ingredient (xanthan gum and/or cellulose gum) was dissolved in deionized water so that the mass of said ingredient will be 1% by mass based on the total mass of the total solution. Fluid characteristics (relation between the shear rate and the viscosity) of the obtained aqueous solutions were measured using a viscoelasticity measuring instrument: MCR501 Rheometer (Anton Parr). In Particular, the viscosity was measured under the condition of GAP 1 mm, 25° C., shear rate from 0.1 to 1000/s, using a corn plate of 25 mm in diameter.

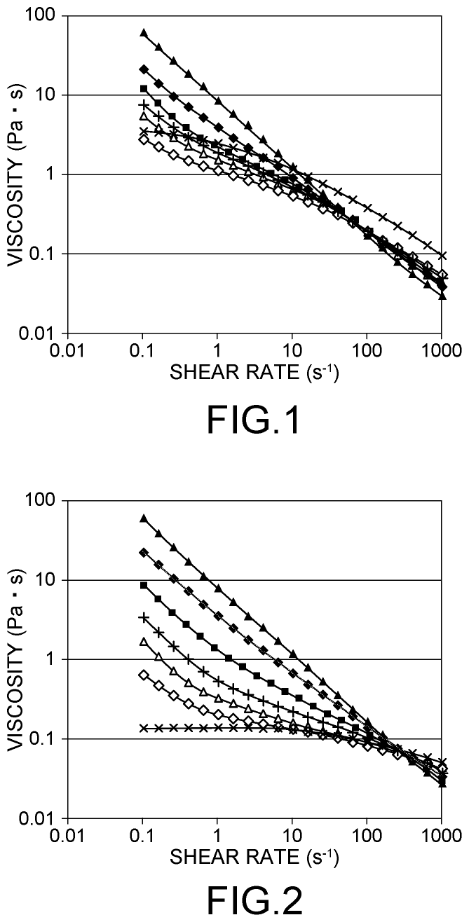

Among the obtained aqueous solutions, the measurement results for the aqueous solutions using BEV150 as cellulose gum is shown in FIG. 1 and BEV130 in FIG. 2. All the aqueous solutions obtained from the composition examples according to the present invention (blends 2 to 5, 8, 11 to 13, 15, and 19) exhibited different fluid characteristics from the comparative example blend 0-80 (only xanthan gum). In particular, the viscosity tended to decrease in the range of low shear rate (0.1 to 105⁻¹), as compared with the case of blend 0-80.

With respect to the thickening compositions of blends 0-80, 3, and 116 to 131, the ingredient (xanthan gum and/or cellulose gum) was dissolved in deionized water so that the mass of said ingredient will be 0.6% by mass based on the total mass of the total solution. Fluid characteristics of the obtained aqueous solutions were measured likewise using a viscoelasticity measuring instrument: MCR501 Rheometer (Anton Parr).

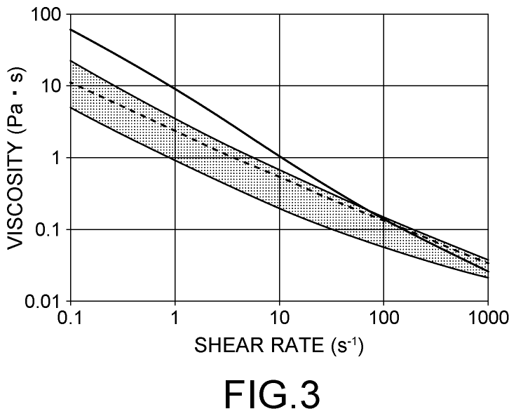

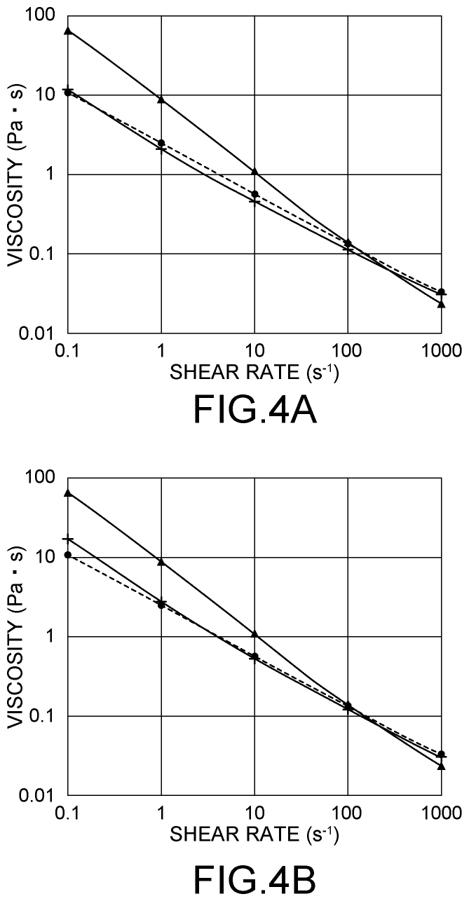

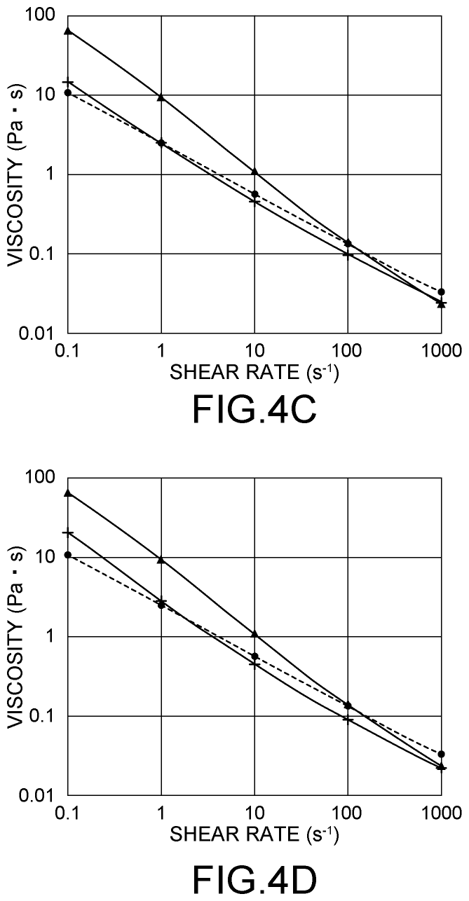

Measurement results are shown in FIG. 3. Individual measurement results of the aqueous solutions obtained from blends 121, 125, 127, and 128 are shown in FIGS. 4A to 4D.

As shown in FIGS. 3 and 4A to D, all the aqueous solutions obtained from the composition examples (blends 3 and 116 to 131) according to the present invention were seen to have a decreasing trend in the range of low shear rate (0.1 to 105⁻¹), as compared with blend 0-80 (only xanthan gum).

### (2) Evaluation of Non-Newtonian Viscosity Index (Fluidity Index)

Based on each measurement value of the fluid characteristics obtained from blend 0-80, BEV130, and blend 19 (the shear stress (Pa) is calculated from multiplying the viscosity (Pa·s) by the shear rate(s⁻¹)), non-Newtonian viscosity index (fluidity index) n were evaluated by applying the viscosity formula of the following formula (1)

[Equation 7]

P=μDⁿ (1)

wherein P represents a shear stress (Pa), D represents a shear rate (s⁻¹), p represents a non-Newtonian viscosity coefficient, and n represents a non-Newtonian viscosity index. Based on each measurement value of the fluid characteristics obtained from BEV150, blends 9, 2, 3, 6, 11, 10, 5, 1, 8, 7, 20, 13, and 14 which were prepared in accordance with the component composition in Table 2 below, non-Newtonian viscosity index (fluidity index) n were also evaluated by applying the viscosity formula of the above formula (1).

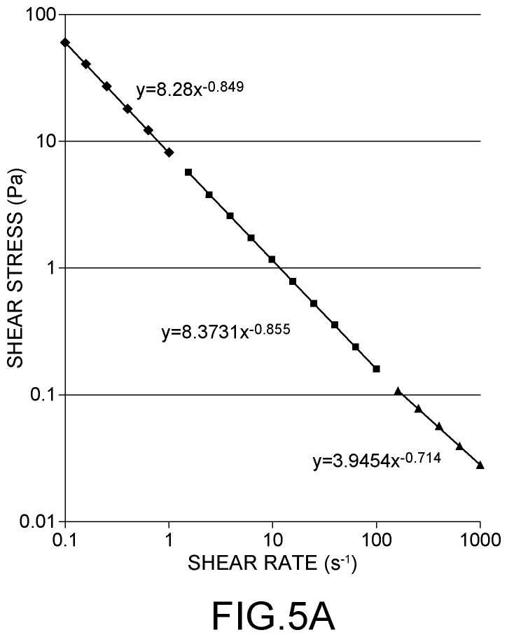

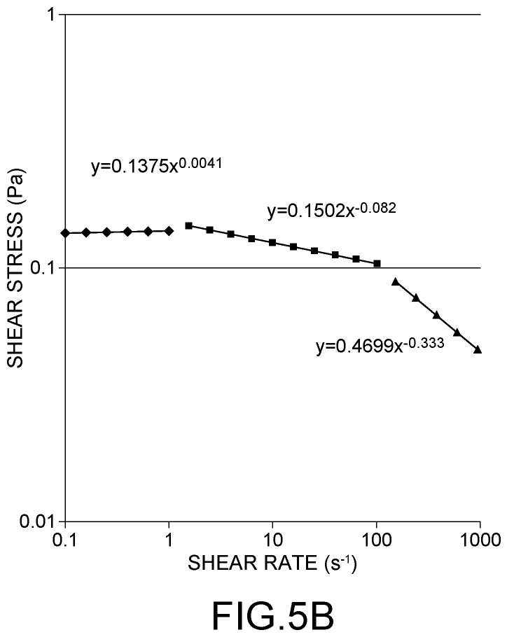

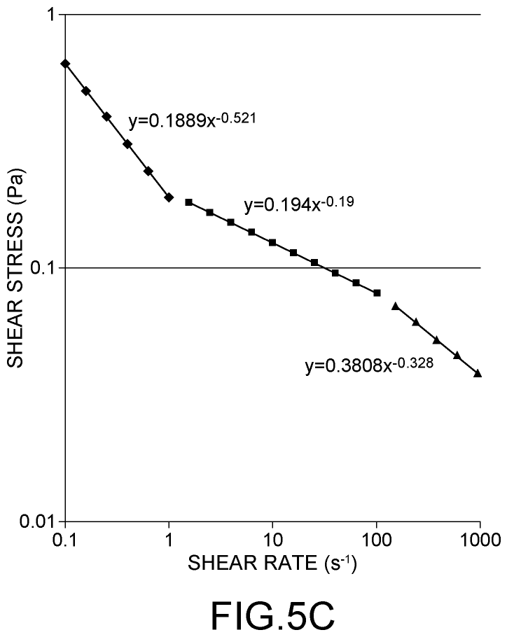

The results obtained from blend 0-80, BEV130, and blend 19 are shown in FIGS. 5A to 5C. The results obtained from BEV150, blends 9, 2, 3, 6, 11, 10, 5, 1, 8, 7, 20, 13, and 14 which were evaluated in the same way as the above are shown together with the results obtained from blend 0-80, BEV130, and blend19 in Table 2.

TABLE 2
Component Composition and Non-Newtonian Viscosity Index n of each
Thickening Composition

| | Component | | | non-Newtonian viscosity | | | Ratio of | |
|---|---|---|---|---|---|---|---|---|
| Blend | composition | | | index n | | | index | |
| No. | XC80 | BEV130 | BEV150 | a | b | c | b/a | c/b |
| 0-80 | 100 | 0 | 0 | −0.849 | −0.855 | −0.714 | 1.01 | 0.84 |
| BEV130 | 0 | 100 | 0 | 0.0041 | −0.082 | −0.333 | −20.00 | 4.06 |
| BEV150 | 0 | 0 | 100 | −0.152 | −0.429 | −0.592 | 2.82 | 1.38 |
| 9 | 50 | 0 | 50 | −0.564 | −0.463 | −0.62 | 0.82 | 1.34 |
| 2 | 50 | 0 | 50 | −0.6 | −0.486 | −0.624 | 0.81 | 1.28 |
| 3 | 40 | 0 | 60 | −0.557 | −0.449 | −0.589 | 0.81 | 1.31 |
| 6 | 40 | 0 | 60 | −0.569 | −0.45 | −0.594 | 0.79 | 1.32 |
| 11 | 60 | 0 | 40 | −0.705 | −0.553 | −0.644 | 0.78 | 1.16 |
| 10 | 60 | 0 | 40 | −0.654 | −0.465 | −0.641 | 0.71 | 1.38 |
| 5 | 60 | 40 | 0 | −0.82 | −0.504 | −0.575 | 0.61 | 1.14 |
| 1 | 60 | 40 | 0 | −0.841 | −0.507 | −0.578 | 0.60 | 1.14 |
| 8 | 50 | 50 | 0 | −0.778 | −0.349 | −0.472 | 0.45 | 1.35 |
| 7 | 50 | 50 | 0 | −0.828 | −0.353 | −0.471 | 0.43 | 1.33 |
| 20 | 40 | 60 | 0 | −0.614 | −0.257 | −0.38 | 0.42 | 1.48 |
| 13 | 40 | 60 | 0 | −0.719 | −0.273 | −0.39 | 0.38 | 1.43 |
| 19 | 30 | 70 | 0 | −0.521 | −0.19 | −0.328 | 0.36 | 1.73 |
| 14 | 30 | 70 | 0 | −0.613 | −0.198 | −0.335 | 0.32 | 1.69 |

Note
1) Values of the component composition of each thickening composition represent part(s) by mass.
Note
2) Concentrations of the ingredient (xanthan gum and/or cellulose gum) in total aqueous solution tested are 1.0% by mass.
Note
3) XC80 represents Xanthan clear 80.

From the above results obtained from blends 9, 2, 3, 6, 11, 10, 5, 1, 8, 7, 20, 13, 19, and 14, when n in the case where the shear rate (s⁻¹) was from 0.1 to 1 was a, and n in the case where the shear rate was higher than 1 to 100 or less was b, and n in the case where the shear rate was higher than 100 to 1000 or less was c, it was revealed that the ratio of c to b (c/b) is 1.1 or higher and the ratio of b to a (b/a) is 0.9 or less.

### Example 2: Thickening Composition Comprising Xanthan Gum and Alginic Acid

Thickening compositions were prepared as shown in the following Table 3 based on the above-described method of Example 1 (1) except that an experimental section was added where alginic acid was used instead of cellulose gum. As for alginic acid, GRINDSTED alginic acid (Du Pont) was used.

TABLE 3
Blending Component of Each Thickening Composition of Example 2

| | Xanthan clear | | BEV |
|---|---|---|---|
| Blend name | 80 | alginic acid | 130 |
| alginic acid | | 100 | |
| BEV130 | | | 100 |
| 0-80 | 100 | | |
| XG/BEV130 | 40 | | 60 |
| XG/Alginate | 40 | 60 | |

With respect to each thickening composition, the ingredient (xanthan gum and/or alginic acid) was dissolved in deionized water so that the mass of said ingredient will be 1% by mass based on the total mass of the total solution. Fluid characteristics (relation between the shear rate and the viscosity) of the obtained aqueous solutions was measured in accordance with the above-described method of Example 1 (1), using a viscoelasticity measuring instrument: MCR501 Rheometer (Anton Parr).

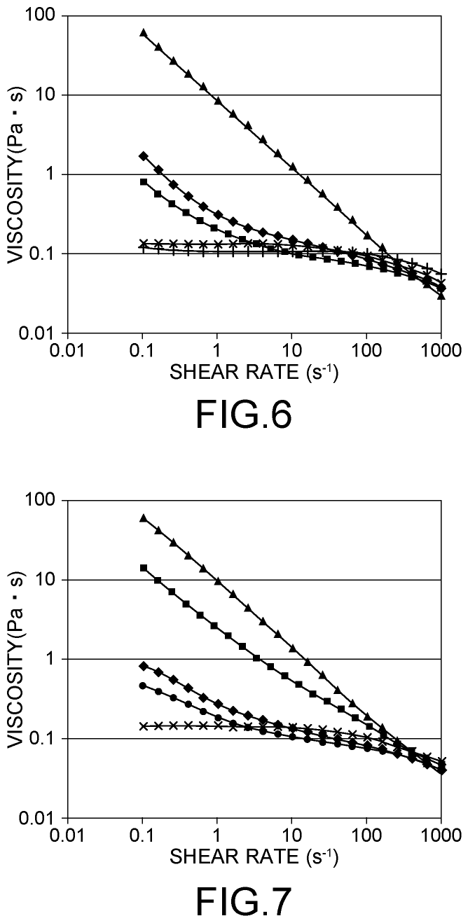

The results are shown in FIG.6.

XG/Alginate (a composition consisted of xanthan gum and alginic acid) showed a different fluid characteristics from blend 0-80(only xanthan gum). In particular, the viscosity tended to decrease in the range of low shear rate (0.1 to 105⁻¹).

### Example 3: Thickening Composition Comprising Succinoglycan and Cellulose Gum

Thickening compositions were prepared as shown in the following Table 4 based on the above-described method of Example 1 (1) except that an experimental section was added where succinoglycan gum was used instead of xanthan gum. As for succinoglycan gum, GRINDSTED succinoglycanJ (Du Pont) was used.

TABLE 4
Blending Component of Each Thickening
Composition of Example 3

| Blend name | succinoglycan | BEV130 |
|---|---|---|
| BEV130 | | 100 |
| succinoglycan | 100 | |
| 34 | 40 | 60 |
| 36 | 60 | 40 |
| 37 | 30 | 70 |

With respect to each thickening composition, the ingredient (succinoglycan and/or cellulose gum) was dissolved in deionized water so that the mass of said ingredient will be 1% by mass based on the total mass of the total solution. Fluid characteristics (relation between the shear rate and the viscosity) of the obtained aqueous solutions was measured in accordance with the above-described method of Example 1 (1), using a viscoelasticity measuring instrument: MCR501 Rheometer (Anton Parr).

The results are shown in FIG. 7.

All the composition examples (blends 34 to 37) of the present invention displayed different fluid characteristics from succinoglycan (only succinoglycan). In particular, the viscosity tended to decrease in the range of low shear rate (0.1 to 105⁻¹).

### Example 4: Sensory Evaluation

Sensory evaluations were performed with respect to the thickening compositions (blends 3, 121, 125, 127, 128, and 0-80) obtained in Example 1.

The sensory evaluations were performed by 8 panellers (healthy individuals), 3 times each for the 11 items in the description of sensory characteristics of the following Table 5 in accordance with IS013299 “Sensory analysis—Methodology—General guidance for establishing a sensory profile”.

TABLE 5
Description of sensory attributes

| | Terminology of Dysphagia UK | |
|---|---|---|
| No. | Attribute | Evaluation method |
| 1 | Ropy | Tilt the sample in the beaker, so as to let the sample |
| | | run up the inside of the beaker. Press the back side of |
| | | a spoon against the sample on the side of the beaker, |
| | | and pull gently outwards, trying to form a thread. |
| | | Evaluate the degree of ropiness, i.e. the length and |
| | | thickness of the thread formed. |
| 2 | Spread- | Take a spoonful of sample and put it on your |
| | ability | tongue. Leave the spoonful on the tongue and |
| | | observe how easily it spreads out over the tongue. A |
| | | little = Thick sample that keeps its form and remains |
| | | on the tongue. Much = Thin sample that easily flows |
| | | of the tongue by itself. |
| 3 | Wetting | When the sample is in the mouth. Evaluate how |
| | | watery it feels in the mouth on the scale: Dry-Wet |
| 4 | Mouth | When the sample is in your mouth, evaluate to which |
| | Coating | degree it coats the oral cavity. |
| 5 | Easy to | Put some sample in your mouth. During swallowing, |
| | swallow | evaluate the degree to which the sample offers |
| | | resistance to swallowing. If the sample offers a large |
| | | amount of resistance, it sticks in the throat = A little |
| | | swallowable. If the sample offers a low amount of |
| | | resistance, it is easy to swallow = Much swallowable. |
| 6 | Lumping | During swallowing, evaluate to which degree it feels |
| | | as if the sample is swallowed in lumps. A little = |
| | | Separates in droplets. Much = Swalloed as |
| | | food(lumps). |
| 7 | Thick flow | Put some sample in your mouth. During swallowing, |
| | | evaluate how thick the sample feels, as it flows down |
| | | your pharynx. |
| 8 | Sticky | To which degree does the sample mass feel sticky in |
| | | your throat during the swallowing-process? |
| 9 | Coherent | Evaluate to which degree the sample mass is |
| | during | coherent, i.e. sticks together during swallowing. |
| | swallow | |
| 10 | Remanent | Evaluate the amount of residue remaining in your |
| | residue | throat after the sample has been swallowed, i.e. |
| | | evaluate how much sample “hangs” in the pharynx or |
| | | the throat after swallow. |
| 11 | Overall | Evaluate the overall impression of swallowability of |
| | swallow- | the sample on the scale: Difficult to swallow-Easy to |
| | ability | swallow. A little = Difficult to swallow/Much = Easy |
| | | to swallow. |

The results by analyzing the obtained sensory evaluation scores with analysis of variance (ANOVA) and Fisher's least significant difference (Fisher's LSD) are shown in Table 6.

TABLE 6
Statistical analysis of sensory evaluation scores (Analysis of variance
and Fisher's least significant difference)

| | | | | | | | | | Overall | | |
|---|---|---|---|---|---|---|---|---|---|---|---|
| Blend | Lump- | Feels | Mouth | Remant | Thick | | | | swallow- | Spread | Easy to |
| Nos. | ing | sticky | Coating | residue | flow | Ropy | Coherent | Wetting | ability | ability | swallow |
| 121 | 5.7 bc | a | 9.4 ab | 9.4 ab | 9.4 | 9.5 a | 7.5 abc | 5.3 bc | 5.4 bcd | 7.1 b | 5.9 bcd |
| | | | | | ab | | | | | | |
| 125 | 4.8 cd | 7.8 | 9.8 a | 9.4 ab | 9.6 | 8.8 | 8.6 ab | 5.9 bc | 6.7 bc | 7.6 b | 7.1 b |
| | | ab | | | ab | ab | | | | | |
| 127 | 4.5 cd | 7.5 | 8.1 bc | 8.4 b | 8.2 b | 7.6 | 8.4 ab | 6.8 b | 7 b | 8.2 b | 7.5 b |
| | | ab | | | | bc | | | | | |
| 128 | 3.4 d | 4.6 c | 5.2 d | 5.3 c | 5.5 c | 5.5 d | 9 a | 9.8 a | 10 a | 10.6 a | 10.8 a |
| 3 | 5.8 bc | 7.4 | 8.8 ab | 9.6 ab | 8.8 b | 9.7 a | 7.6 abc | 6 b | 6.5 bc | 7.3 b | 6.5 bc |
| | | ab | | | | | | | | | |
| 0-80 | 9 a | 8.4 a | 9 ab | 9.4 ab | 10.4 a | 6 cd | 5.3 c | 5.5 bc | 4.9 cd | 5.1 c | 5.2 cd |

Note)
No significant differences are found between the scores indicated with the same letters (p < 0.05).

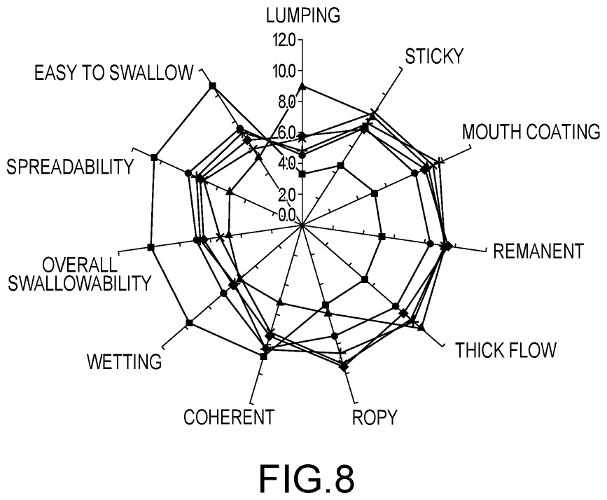

The statistical analysis results of the sensory evaluation scores are shown in a sensory spider diagram (FIG. 8). The positive items are shown on the left side and the negative items on the right side.

As shown in Table 6 and FIG. 8, the composition examples (blends 3, 121, 125, 127, and 128) of the present invention had preferable Easy to swallow, Spreadability, Overall Swallowability, and Wetting as compared with blend 0-80 (only xanthan gum). Especially, blend 128 had the most improved Easy to swallow, Spreadability, Overall Swallowability, and Wetting.

1. A composition comprising a first thickener and a second thickener for providing thickness to foods and drinks and improving swallowability for foods and drinks, wherein
the first thickener shows pseudoplasticity at the shear rate from 1 to 100S ⁻¹,
the second thickener shows Newtonian viscosity at the shear rate from 1 to 100 S⁻¹ and the thickeneing effect when the first and the second thickeners are used in combination in an equal amount is equal to or less than an additive level of the thickening effect when each were used alone.

2. The composition according to claim 1, wherein n is from −1 to −0.7 when fluid characteristics of the first thickener are expressed by the following formula (1):
[Equation 1]
P=μDⁿ (1)
wherein P represents the shear stress (Pa), D represents the shear rate (s⁻¹), p represents a non-Newtonian viscosity coefficient, and n represents a non-Newtonian viscosity index.

3. The composition according to claim 1, wherein
the first thickener is at least one selected from the group consisting of xanthan gum, succinoglycan gum, gellan gum fluid gel, and crystalline cellulose.

4. The composition according to claim 1, wherein n is from −0.15 to 0.15 when fluid characteristics of the second thickener is expressed by the following formula (1):
[Equation 2]
P=μDⁿ (1)
wherein P represents the shear stress (Pa), D represents the shear rate (s⁻¹), μ represents a non-Newtonian viscosity coefficient, and n represents a non-Newtonian viscosity index.

5. The composition according to claim 1, wherein the second thickener is at least one selected from the group consisting of carboxymethyl cellulose, guar gum, alginic acid and pectin.

6. The composition according to claim 1 for ingestion aid for a person with dysphagia, wherein said composition is ingested as a mixture with foods and drinks.

7. The composition according to claim 1, wherein the mass ratio of the first thickener to the second thickener (first thickener/second thickener) is from 20/80 to 90/10.

8. The composition according to claim 1, wherein the content of the first thickener is from 15 to 95% by mass.

9. The composition according to claim 1, wherein the content of the second thickener is from 5 to 85% by mass.

10. The composition according to claim 1, wherein the total mixed amount of the first and the second thickeners is from 0.1 to 3% by mass based on the whole amount of a mixture of said composition and foods and drinks.

11. The composition according to claim 2, wherein the ratio of c to b (c/b) is 1.1 or more and the ratio of b to a (b/a) is 0.9 or less when fluid characteristics of said composition is expressed by the following formula (1):
[Equation 3]
P=μDⁿ (1)
wherein P represents the shear stress (Pa), D represents the shear rate (s⁻¹), p represents a non-Newtonian viscosity coefficient, and n represents a non-Newtonian viscosity index,
when n is a if D is from 0.1 to 1, n is b if D is greater than 1 to 100 or less, and n is c if D is greater than 100 to 1000 or less in formula (1).

12. The composition according to claim 1, wherein said composition is in a liquid form, powder, or a granular form.
